(19) United States
(12) Patent Application Publication
(10) Pub. No.: US 2014/0204752 A1
(43) Pub. Date: Jul. 24, 2014

(54) PACKET PROCESSING SYSTEM PROCESSING PACKETS BY PLURAL PROCESSORS

(71) Applicant: Oki Electric Industry Co., Ltd., Tokyo (JP)

(72) Inventor: Shugo SHIBA, Tokyo (JP)

(73) Assignee: OKI ELECTRIC INDUSTRY CO., LTD., Tokyo (JP)

(21) Appl. No.: 14/134,757

(22) Filed: Dec. 19, 2013

(30) Foreign Application Priority Data
Jan. 18, 2013 (JP) 2013-007693

(51) Int. Cl. H04L 12/801

(52) U.S. Cl. CPC H04L 47/12
USPC 370/235

(57) ABSTRACT

A packet processing apparatus includes plural packet processors processing input packets constituting an input packet stream. A flow identification information manager holds flow identification information about flows included in the input packet stream. A flow assigner assigns each of the flows to one of the packet processors. A packet identifier determines, based on the flow identification information, one of the flows to which the input packet belongs. A packet distributor supplies the input packet to the determined packet processor according to a result of determination made by the packet identifier.

### BACKGROUND OF THE INVENTION

1. Field of the Invention

The present invention relates to a packet processing system and a method therefor, and more particularly to a packet processing apparatus applicable, for example, to SBCs (Session Border Controllers) processing packets transmitted between the networks of communication common carriers.

2. Description of the Background Art

Conventionally, in some instances, SBCs are disposed between the networks of communication common carriers. Such an SBC performs packet processing such as address conversion, e.g. network address translation (NAT), and codec conversion performed, for example, when providing IP (Internet Protocol) phone services.

Since SBCs are used to interconnect the networks of communication common carriers, they may be required to process a huge number of packets at high speed. Conventional solutions for improving the performance of SBCs are disclosed in Japanese patent laid-open publication No. 2009-200658 to Ozawa and Japanese patent laid-open publication No. 2011-071701 to Amano.

Ozawa discloses a media gateway (MGW) equipped with an SBC, which has an event buffering function capable of monitoring service levels such as telephone speech quality even for a large scale of subscribers.

Amano discloses an additional means for analyzing the extension header of a received packet and generating a packet by adding a result of the analysis to the received packet in order to perform processing appropriately for the extension header of the packet without burdening additional load on the CPU (central processing unit).

However, the solutions set forth in Ozawa and Amano could not improve the performance of SBCs adaptively to varying traffic. For example, SBCs installed in a communication common carrier may be required to have scalability for improving the performance in conformity with increase in traffic, rather than installing large-scale equipment from the beginning. As a matter of course, SBCs are also required to process packets efficiently while maintaining scalability.

### SUMMARY OF THE INVENTION

It is therefore an object of the present invention to provide a packet processing system, a packet processing apparatus and a method therefor capable of processing packets efficiently while maintaining scalability.

In accordance with the present invention, in a packet processing apparatus including a plurality of packet processors processing input packets constituting an input packet stream, flow identification information about flows included in the input packet stream is held in a flow identification information manager, and each of the flows is allotted to one of the packet processors. The flow identification information is used to determine which one of the flows the input packet belongs to, and, according to a result of determination thus made, that input packet is supplied to the allotted, and hence determined, packet processor.

According to the present invention, it is possible to process packets efficiently while maintaining scalability.

The inventive concept disclosed in the application may also be defined in ways other than in the claims presented below. The inventive concept may consist of several separate inventions particularly if the invention is considered in light of explicit or implicit subtasks or from the point of view of advantages achieved. In such a case, some of the attributes included in the claims may be superfluous from the point of view of separate inventive concepts. Within the framework of the basic inventive concept, features of different embodiments are applicable in connection with other embodiments.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing the general configuration of a communication system in accordance with an illustrative embodiment of the present invention;

FIG. 2 is a schematic block diagram showing the functional configuration of a packet processing apparatus in accordance with the illustrative embodiment shown in FIG. 1;

FIG. 3 schematically shows an example of an internal packet processed within the packet processing apparatus in accordance with the illustrative embodiment;

FIG. 4 shows in the form of table exemplified control information held in an identification information controller shown in FIG. 2;

FIG. 5 shows also in the form of table exemplified control information held in a packet identifier shown in FIG. 2;

FIG. 6 shows also in the form of table exemplified control information held in a packet distributor shown in FIG. 2;

FIG. 7 is a flowchart useful for understanding the operation of the packet processing apparatus in accordance with the illustrative embodiment;

FIG. 8 shows in the form of table how the exemplified control information shown in FIG. 4 is held and updated in the identification information controller shown in FIG. 2;

FIG. 9 shows in the form of table how the exemplified control information shown in FIG. 5 is held and updated in the packet identifier shown in FIG. 2; and

FIG. 10 shows in the form of table how the exemplified control information shown in FIG. 6 is held and updated in the packet distributor shown in FIG. 2.

### DESCRIPTION OF THE PREFERRED EMBODIMENT

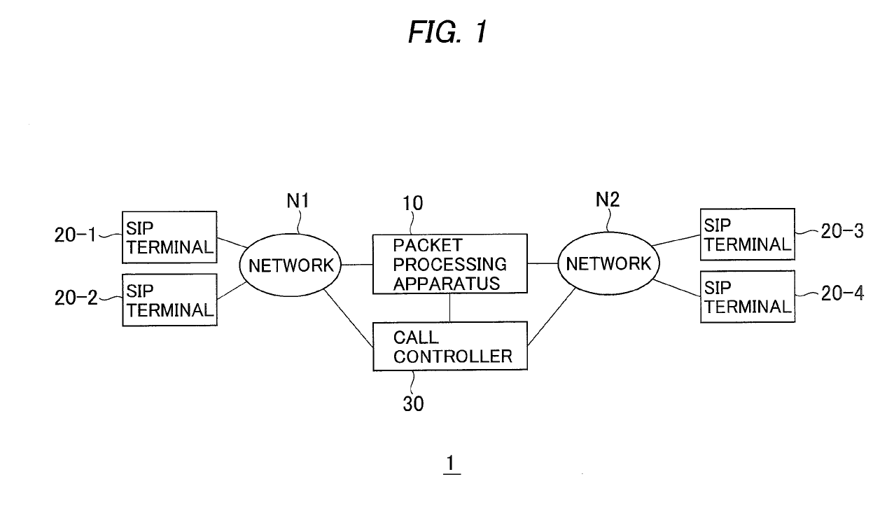

With reference to the accompanying drawings, an illustrative embodiment of a packet processing system in accordance with the present invention will be described in detail. FIG. 1 shows the general configuration of a telecommunications system 1 in accordance with the illustrative embodiment.

As shown in FIG. 1, in the telecommunications system 1, a packet processing apparatus 10 and a call controller 30 may be disposed between telecommunications networks N1 and N2. The networks N1 and N2 can be interconnected via the packet processing apparatus 10 and the call controller 30. In the illustrative embodiment, the networks N1 and N2 may be IP (Internet Protocol) networks in which communications between SIP (Session Initiation Protocol) communication terminals 20-1 to 20-4 are controlled or subjected to call control according to SIP prescribed in Request for Comments (RFC) 3261. The SIP communication terminals 20-1 to 20-4 are communication terminals compliant with the SIP, and with the illustrative embodiment the four terminals 20-1 through 20-4 are included in the system 1. When each of the terminals 20-1 to 20-4 need not specifically be referred to, they may collectively be designated with a reference numeral 20. The SIP terminal 20 are adapted to send and receive messages, for example, and/or perform media communications, e.g. voice or video calls, under call control based on SIP. In the illustrative embodiment, end-to-end packets communications may be established between the SIP terminals 20. Existing communication terminals compliant with SIP can be used as the SIP terminals 20 and hence a detailed description thereof is omitted.

In the illustrative embodiment, for simplicity, two of the SIP terminals 20-1 and 20-2 may be disposed in the one network N1, and other two of the SIP terminals 20-3 and 20-4 may be arranged in the other network N2. The number of the networks interconnected by the packet processing apparatus 10 and the internal configuration of those networks connected thereto may not be restricted to those of the embodiment.

Further, in the illustrative embodiment, the call controller 30 may perform call control between the networks N1 and N2 using exchanges of SIP messages. Under the call control, media communications via the packet processing apparatus 10 are performed between the networks N1 and N2. The media communications may employ, for example, media packets in which inserted are media data such as voice data produced on voice calls. It is not specifically restricted to the illustrative embodiment how the packet processing apparatus 10 processes packets. However, for illustration only, the following description will proceed to an example of the apparatus 10 being adapted for address conversion such as network address translation (NAT) adaptive to a destination network. Further, in the communication system 1 shown in FIG. 1, the call controller 30 is the sole call controlling means disposed. However, the call control may of course be performed in coordinate with call controllers such as SIP servers, not shown, located on the networks.

The call controller 30 is an SIP server providing call control using SIP messages between the networks N1 and N2. The call controller 30 also performs processing for providing control information on the call control to the packet processing apparatus 10, as described in detail later. It is not restricted how the networks are connected between the call controller 30 and the packet processing apparatus 10, for which various types of connection can be configured. FIG. 1 exemplifies that the call controller 30 and the packet processing apparatus 10 are interconnected using segments that are different between the networks N1 and N2.

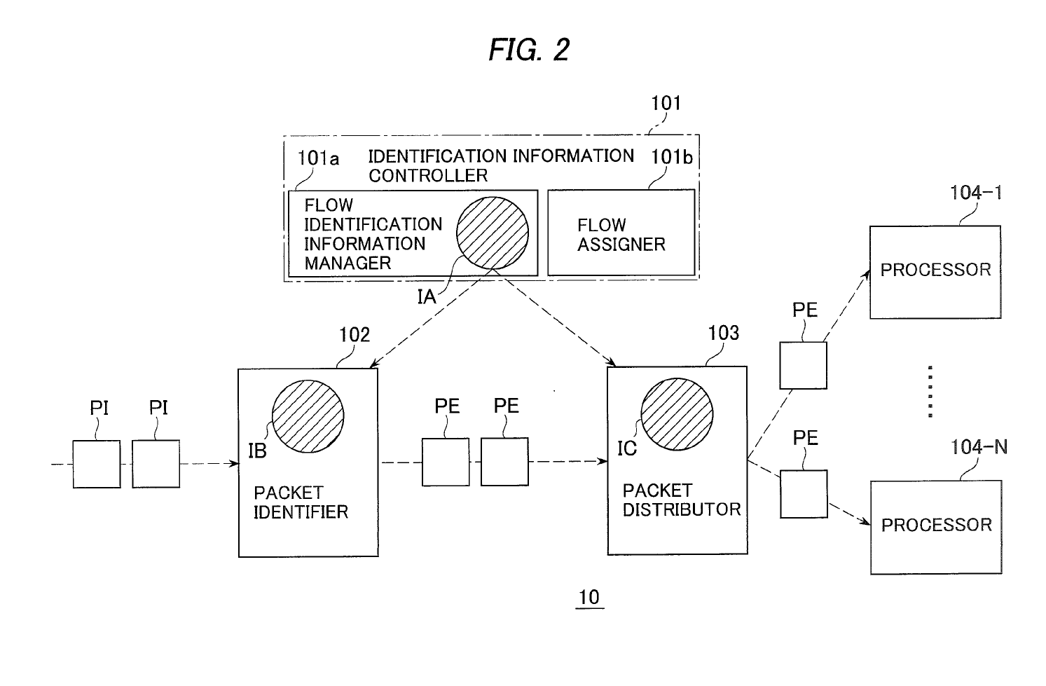

FIG. 2 shows the internal configuration of the packet processing apparatus 10. As shown in the figure, the packet processing apparatus 10 may generally include an identification information controller 101, a packet identifier 102, a packet distributor 103 and a plurality (N) of processors 104 (104-1 to 104-N) for processing packets, where N is a natural number. Those components are interconnected as conceptually illustrated with dotted lines, as will be understood later on, such that the packet processing apparatus 10 processes input packets forming an input packet stream designated with reference letters PI in FIG. 2. The system 1 includes physical interfaces with the networks, not shown in the figure just for simplicity. Also for simplicity, the packet processing apparatus 10 shown in FIG. 2 is adapted to process packets on plural paths altogether by the packet identifier 102, the packet distributor 103 and the processors 104 (104-1 to 104-N). More specifically, they deal with packets flowing in the opposite directions altogether, namely, from the network N1 toward the network N2 and vice versa.

The identification information controller 101 is adapted to distinguish, under the control of the call controller 30, flows conveyed by an input packet stream, which form respective end-to-end packet communications between the SIP terminals 20, to manage the distinguished flows. Specifically, the identification information controller 101 includes a flow identification information manager 101a, which may hold and update control information IA under the control of the call controller 30, thus managing the flows. The flow identification information manager 101a, and more generally the identification information controller 101, controls the packet identifier 102 and the packet distributor 103 according to the content of the held control information IA.

As described above, in the illustrative embodiment, the identification information controller 101 distinguishes flows conveyed by an input packet stream based on a notice given from the call controller 30. For example, the call controller 30 may convey, according to the content of call control to be performed, information about flows of sessions, or calls, newly originated or ended to the identification information controller 101 of the packet processing apparatus 10.

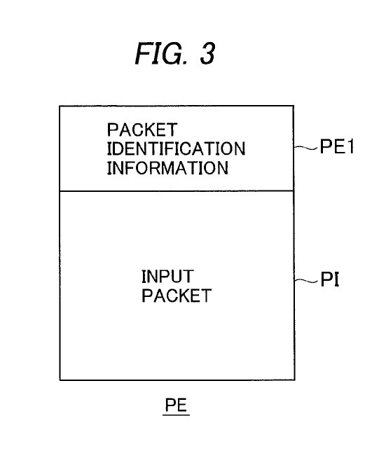

The packet identifier 102 is adapted for identifying the processing unit of input packets under the control of the identification information controller 101. In the illustrative embodiment, the packet identifier 102 may identify which flow the received packets belong to. The packet identifier 102 assembles intra-system, or internal, packets PE, FIG. 3, based on the input packets PI and supplies the internal packets PE to the packet distributor 103. As shown in FIG. 3, the internal packet PE comprises a field containing an input packet PI, and a header field added to the input packet and containing packet identification information PE1. The packet identification information PE1 includes the results of identification performed by the packet identifier 102, namely a flow identification (ID) number described later.

The packet distributor 103 is adapted to selectively providing, under the control of the identification information controller 101, a supplied internal packet PE, containing an input packet PI, to either one of the processors 104 according to a result from the identification performed by the packet identifier 102. Specifically, the packet distributor 103 uses the packet identification information PE1 included in a supplied internal packet PE to determine which one of the processors 104 the supplied internal packet PE is to be delivered.

The processors 104-1 to 104-N are adapted to process input packets PI inserted in internal packets PE supplied from the packet distributor 103. The processors 104 serve as processing input packets PI and sending out the processed packets to destination networks via interfaces, not shown, with the destination networks. The processors 104 may have respective processor numbers, or identifiers, allotted specifically to the respective processors in order to distinguish themselves from each other. With the illustrative embodiment, the processors 104-1 to 104-N have the processor numbers 1 to N allotted, respectively.

The processors 104 may process a variety of packet processing, such as NAT, which may be any of packet processing operations conducted by SBCs (Session Border Controllers). Therefore, detailed descriptions thereof are omitted.

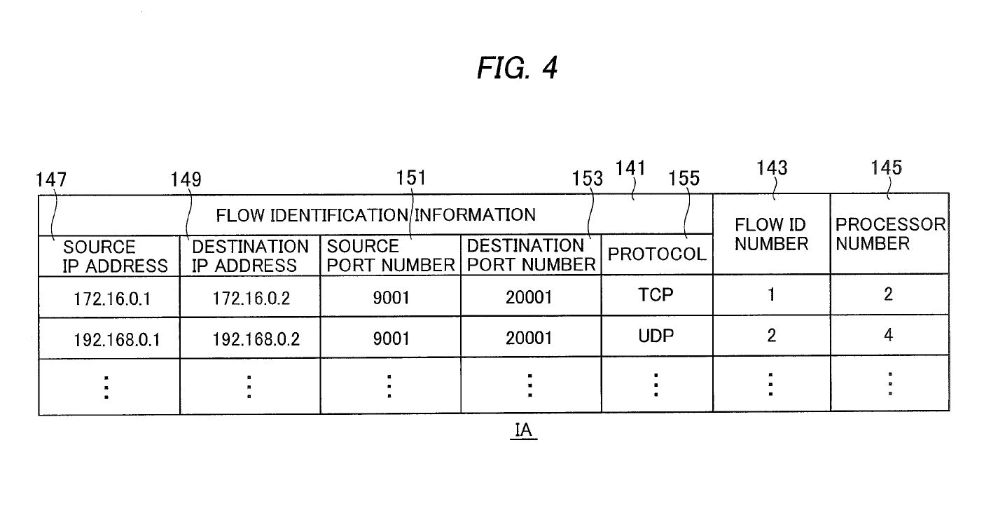

Next, it will be described how the identification information controller 101 manages flows. FIG. 4 shows an example of control information IA managed by the controller 101 in the form of table. As seen from the figure, the table of control information IA includes entries, i.e. rows, formed flow by flow. Each entry comprises a field 141 for storing therein flow identification information identifying a flow for use in identifying which flow a packet in question is involved in, a field 143 for storing therein a flow ID number serving as an identifier specific to a flow in question, and a field 145 for storing therein a processor number serving as an identifier specific to one of the processors 104 which is associated with the flow. The information stored in those data fields is mapped to one another for management. In the table of FIG. 4, each row, or line, indicates information about one flow.

So far as flow identification information obtained from an input packet PI is used for enabling a flow to be identified, no restrictions are imposed on what data items of the flow identification information the table of control information IA is comprised of. In the illustrative embodiment, the flow identification information field 141 may include sub-fields of a source IP address 147, a destination IP address 149, a source port number 151, a destination port number 153 and a protocol (protocol name) 155.

In the flow identification information field 141, the source IP address sub-field 147 contains a source IP address included in the IP header of an input packet PI. The destination IP address sub-field 149 contains a destination IP address included in the IP header of the input packet PI. The source port number sub-field 151 stores therein a source port number contained in the UDP (User datagram protocol) or TCP (Transmission control Protocol) header of the input packet PI. The destination port number sub-field 153 contains a destination port number included in the UDP or TCP header of the input packet PI. Further, the protocol sub-field 155 stores therein the name or identification of a protocol contained in the IPv4 header in the case of IPv4 (Internet Protocol version 4), or of a protocol contained in the Next Header field of the IPv6 (Internet Protocol version 6) header in the case of IPv6.

Returning to FIG. 2, the identification information controller 101 of the packet processing apparatus 10 may generally include a flow identification information manager 101a and a flow assigner 101b. The flow identification information manager 101a obtains, from the call controller 30, flow identification information about flows included in input packet streams. For instance, the call controller 30 may serve as a flow identification information acquirer that can analyze the content of SIP signals, e.g. SIP message such as INVITE message, supplied from the SIP terminals 20 to obtain flow identification information on the flows. Then, the flow assigner 101b of the identification information controller 101 assigns flows, more specifically pieces of flow identification information, of which the call controller 30 has notified the controller 101 to respective flow ID numbers and processor numbers.

As far as the flow assigner 101b can allot flow ID numbers specifically to flows simultaneously processed, no restrictions are placed on how the flow ID numbers are allotted to the flows. Also, no restrictions are imposed on how the flow assigner 101b assigns the processor numbers of the processors 104 to flows. However, a load balancing algorithm, or dispatch scheme, may be preferable in assigning flows to the processors 104 since the loads are distributed equally onto the processors 104. The flow assigner 101b can employ various load balancing algorithms, e.g. an algorithm for assigning the processor number of a processor that is least in the amount of flows being processed, or a round-robin method.

Now, it will be described how the packet identifier 102 identifies packets. Under the control of the identification information controller 101, specifically the flow identification information manager 101a, the packet identifier 102 holds and manages control information IB and identifies input packets PI by means of the control information IB thus held. Specifically, the packet identifier 102 uses the control information IB to recognize the flow ID numbers of the input packets PI. Then, the packet identifier 102 forms a header including packet identification information PE1 that includes the recognized flow ID number to add the header to the input packet PI to thereby assemble an internal packet PE, and supplies the assembled internal packets PE to the packet distributor 103.

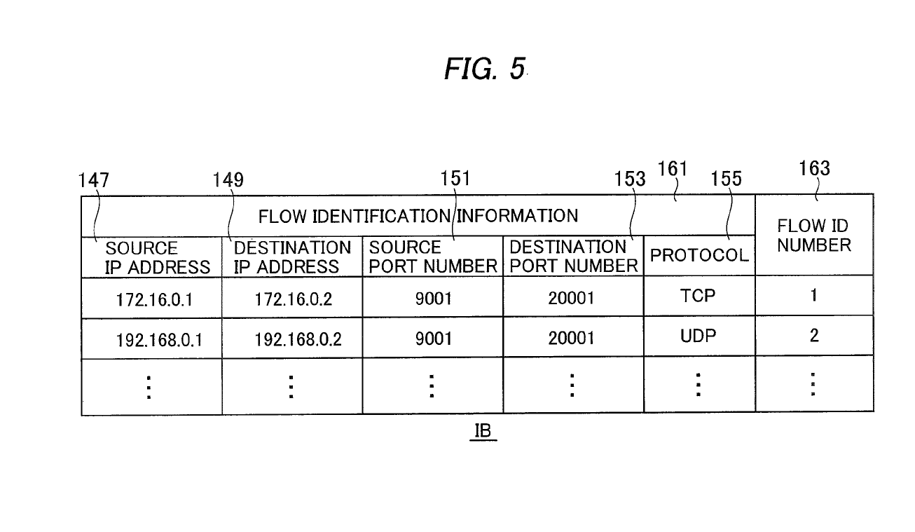

FIG. 5 shows an example of control information IB kept and managed by the packet identifier 102 in the form of table. As can be seen from the figure, the table of control information IB includes entries, or lines, formed flow by flow. Each entry comprises a field 161 for storing flow identification information therein and a field 163 for storing a flow ID number therein. The information stored in those fields is mapped to each other for management. As understood from the table, the control information IB consists of data items of the flow identification information 141 and the flow ID number 143 extracted from the control information IA held in the identification information controller 101. In the table of FIG. 5, each row indicates information about one flow.

In order to make the flow identification information 161 consistent with the flow identification information 141, the identification information controller 101, more specifically the flow identification information manager 101a, is adapted to feed, whenever updating its control information IA, information on the content of the updating to the packet identifier 102. The packet identifier 102 then updates its control information IB based on the information thus fed and holds the updated control information IB.

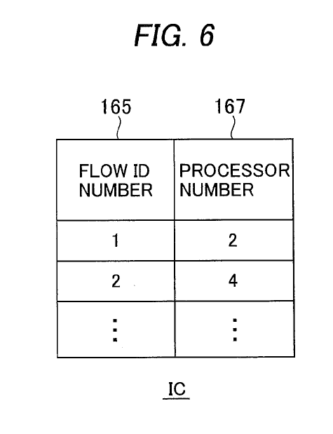

Next, it will be described how the packet distributor 103 distributes packets. Under the control of the identification information controller 101, specifically the flow identification information manager 101a, the packet distributor 103 holds and manages control information IC, FIG. 6, and assigns packets to appropriate ones of the processors 104 according to the held control information IC.

FIG. 6 shows an example of control information IC the packet distributor 103 keeps and manages in the form of table. As shown in the figure, the table of control information IC includes entries, or rows, formed flow by flow. Each entry comprises a field 165 for storing a flow ID number therein and a field 167 for storing a processor number therein. The information stored in those data fields is mapped to each other for management. As can be seen from the figure, the control information IC consists of data items of the flow ID number 143 and the processor number 145 extracted from the control information IA held in the identification information controller 101. In the table of FIG. 6, each row indicates information about one flow.

The packet distributor 103 uses packet identification information PE1 contained in an internal packet PE supplied from the packet identifier 102 to obtain from the control information IC a processor number 167 associated with a flow ID number 165 included in the packet identification information PE1. Then, the packet distributor 103 delivers the supplied internal packet PE to one of the processors 104 corresponding to the obtained processor number 167.

In order to maintain the control information IC to be consistent with the control information IA, the identification information controller 101, more specifically the flow identification information manager 101a, is adapted to supply, whenever updating its control information IA, information about the content of the updating to the packet distributor 103. The packet distributor 103 in turn updates its control information IC according to the supplied information and holds the information IC thus updated.

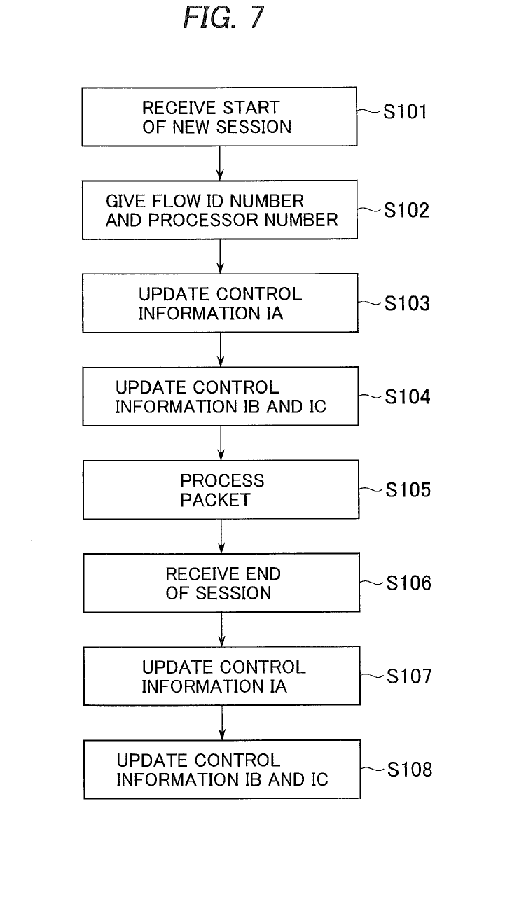

Next, it will be described how the packet processing apparatus 10 operates, more specifically how to process packets, in the illustrative embodiment configured as described above. FIG. 7 is a flow chart useful for understanding how the packet processing apparatus 10 operates from the start to the end of processing packets of a new flow. In the initial state prior to the start of the control flow shown in the figure, it is assumed that the control information IA, IB and IC are in the states of FIGS. 4, 5 and 6, respectively.

First, there occurs a connection request by means of, e.g. an INVITE message, for a new call to be set up over the networks N1 and N2, and the call controller 30 is responsive to the call connection request to perform call control for establishing a calling session. Specifically, the call controller 30 receives from one of the SIP terminals 20-2, for example, belonging to one network N1 an INVITE message specifying the URI (Uniform Resource Identifier) of another of the SIP terminals 20-4 belonging to the other network N2. Triggered by the reception of the INVITE message, the call controller 30 exchanges SIP messages to thereby carry out call control between the SIP terminals 20-2 and 20-4, and controls the SIP terminals 20-2 and 20-4 to prompt the terminals 20-2 and 20-4 to conduct media communication sessions to be established via the packet processing apparatus 10. Then, the call controller 30 obtains flow identification information associated with the media communications between the SIP terminals 20-2 and 20-4, and supplies the obtained information to the identification information controller 101, specifically to the flow identification information manager 101a, of the packet processing apparatus 10. The call controller 30 analyzes the portion of the INVITE message which is described with SDP (Session Description Protocol), for example, to thereby allow flow identification information to be obtained about each flow.

Then, as shown in the flowchart of FIG. 7, in the identification information controller 101 of the packet processing apparatus 10, when the flow identification information manager 101a receives the flow identification information from the call controller 30 (S101), the flow assigner 101b allots a flow ID number and a processor number to the flow associated with that flow identification information, i.e. to the received flow identification information (S102), and updates the control information IA (S103). The above allotment is performed for flow by flow, i.e. for each flow identification information.

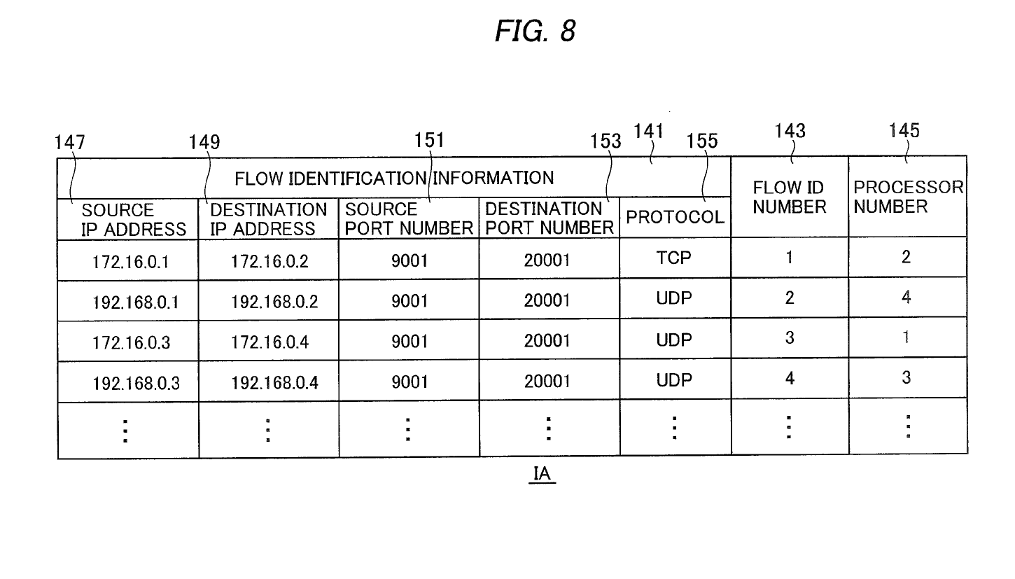

In this example, the control information IA is updated by the identification information controller 101 to the content shown in FIG. 8. In the table shown in FIG. 8, the flows having the flow ID numbers thereof being “3” and “4” have information newly added. In this example, the flow bearing its flow ID number “3” indicates a flow of packets (UDP packets) sent out from the one SIP terminal 20-2 directed to the other SIP terminal 20-4. The flow bearing its flow ID number “4” indicates a flow of packets sent out from the other SIP terminal 20-4 meant for the one SIP terminal 20-2.

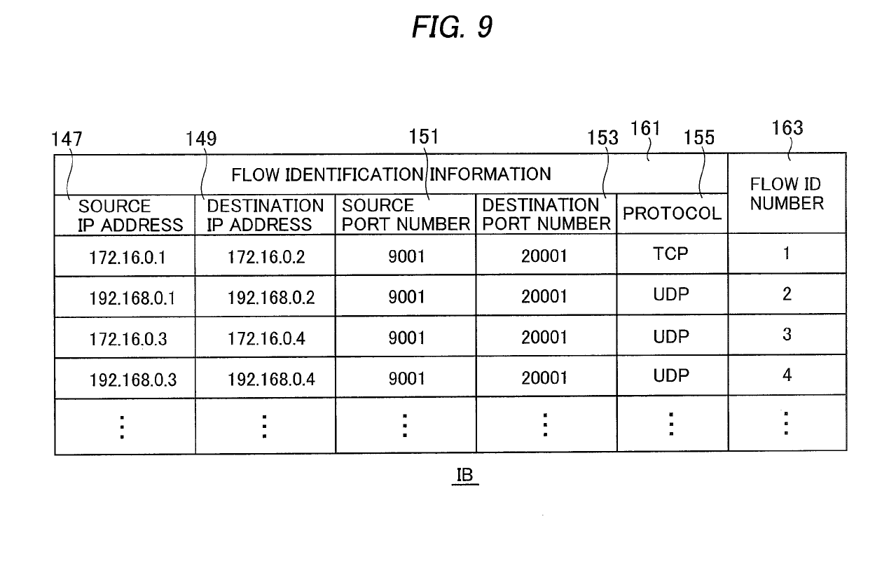

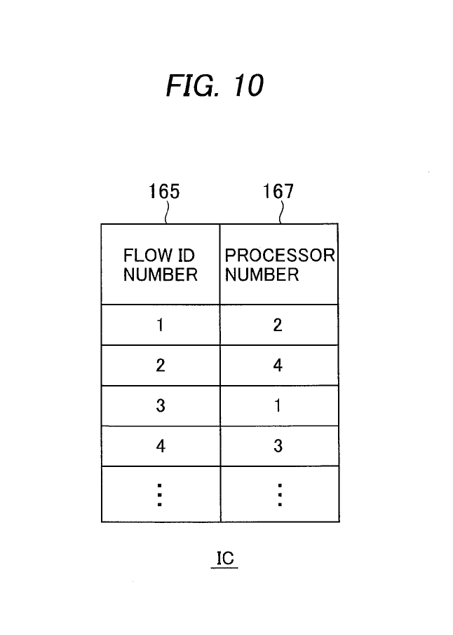

When updating the control information IA, the identification information controller 101, more particularly the flow identification information manager 101a, controls the packet identifier 102 and the packet distributor 103 so as to also update the control information IB and the control information IC, respectively, for synchronization with the updated control information IA (S104). The control information IB and IC thus updated is shown in FIGS. 9 and 10, respectively. As seen from both figures, information about the flows having flow ID numbers “3” and “4” is added to both of the control information IB and IC.

The completion of the update of the control information IA, IB and IC renders the packet processing apparatus 10 to be allowed to process packets in the flows associated with the new sessions, namely, the flows having the flow ID numbers “3” and “4”. Whenever a corresponding packet arrives, the packet is processed (S105).

Subsequently, when the call controller 30 receives a request for releasing the session from either of the SIP terminals 20-2 and 20-4, it carries out call control for terminating the session. In turn, the call controller 30 obtains the flow identification information about the flow associated with the session end request, and supplies the obtained information to the identification information controller 101, more particularly the flow identification information manager 101a, of the packet processing apparatus 10. For example, the call controller 30 analyzes an SIP message associated with the call control for the session termination, thereby allowing the flow identification information to be identified about each flow. In this example, flow identification information about a flow associated with the session to be ended the call controller 30 has identified is the flow identification information associated with its flow ID numbers “3” and “4” shown in FIG. 8.

When the identification information controller 101 of the packet processing apparatus 10 receives the flow identification information from the call controller 30 (S106), the identification information controller 101, more specifically the flow identification information manager 101a, deletes information about the corresponding flow, namely information (rows) about the flow ID numbers “3” and “4”, from the control information IA (S107). As a result of the deleting, the content of the control information IA returns to what is shown in FIG. 4.

When updating the control information IA, the identification information controller 101, more specifically the flow identification information manager 101a, controls the packet identifier 102 and the packet distributor 103 so as to also update the respective control information IB and IC for synchronization with the updated control information IA (S108). As a result, the contents of the control information IB and IC return to the contents of FIGS. 5 and 6, respectively.

In accordance with the illustrative embodiment described so far, the packet processing apparatus 10 identifies packets flow by flow and determines, for each flow, which of the processors is to be used to process the packets contained in the flow, thereby balancing load on processing between the plural processors 104. Consequently, the packet processing apparatus 10 can increase or decrease the processors 104 to be involved adaptively to the amount of processing predominantly required, thus processing packets generally at a required rate. The packet processing apparatus 10 is adapted to select the processors that are to deal with flows on a flow by flow basis to thereby attain load distribution on packet processing in the form of asymmetric multiprocessing (AMP).

For example, a type of packet processing apparatus including plural processors running in a symmetric multiprocessing mode (SMP) may be inferior in the efficiency of packet possessing because the processing capacity has to be improved by means of its OS (Operating System) so as to share the load by those processors on a program by program basis. Specifically, in such an apparatus, the overhead caused by sharing memory and a specific processor being required to be involved in hardware-based processing attendant on network-related processing may be deteriorate the availability of those processors and make it difficult to perform packet processing at higher rates. In addition, in a packet processing apparatus that achieves load sharing by a symmetric multiprocessing, the plural processors deal with one packet. That means it may be difficult to increase or decrease the processors while being in operation.

In contrast, the packet processing apparatus 10 of the illustrative embodiment adapted for selecting processors to process packets by means of asymmetric multiprocessing on a flow by flow basis is free from the overhead otherwise caused by sharing memory and the difficulty otherwise caused by a particular processor being burdened with hardware-based processing associated with network-related processing. This maximizes the availability of the processors and accomplishes high-speed packet processing. Additionally, in the packet processing apparatus 10 of the illustrative embodiment, since each packet is processed by one processor, it is easy to increase or decrease the number of processors 104 while they are in operation.

The scope of the present invention is not limited to the above-described specific embodiment, but alternative embodiments may be provided in accordance with the present invention. In the above-described embodiment, the packet processing apparatus 10 has the plural processors 104, each of which may be a physically separate unit functioning as a packet-processing unit. Alternatively, those processors 104 may be configured such that, for example, at least either one or each of the processors 104 may be one of the plural cores of a single multicore CPU.

In addition, in the above embodiment, the packet processing apparatus 10 and the call controller 30 are units separate from each other. Alternatively, they may of course be formed as an integrated apparatus, i.e. in the form of SBC.

Further, in the above-described embodiment, the packet processing apparatus 10 is configured to receive flow identification information from the call controller 30. Alternatively, the packet processing apparatus 10 may be adapted to analyze SIP messages flowing between networks to obtain flow identification information.

Furthermore, in the above embodiment, the packet processing apparatus functions as an SBC. Alternatively, the packet processing apparatus may function as a system such as a media gateway other than an SBC.

The entire disclosure of Japanese patent application No. 2013-007693 filed on Jan. 18, 2013, including the specification, claims, accompanying drawings and abstract of the disclosure, is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A packet processing apparatus comprising:
a plurality of packet processors each processing an input packet included in an input packet stream;
a flow identification information manager holding flow identification information about flows included in the input packet stream;
a flow assigner assigning each of the flows to either one of said plurality of packet processors;
a packet identifier operative in response to the flow identification information for determining one of the flows to which the input packet belongs to produce a result of determination; and
a packet distributor operative in response to the result of determination for supplying the input packet to the determined packet processor.

2. The apparatus in accordance with claim 1, wherein each of said plurality of packet processors is constituted of a single processor.

3. The apparatus in accordance with claim 1, wherein the input packet is an IP (Internet Protocol) packet, the identification information being obtained from header information of the IP packet.

4. A method in a packet processing apparatus in which a plurality of packet processors each process an input packet included in an input packet stream, comprising:
holding flow identification information about flows included in the input packet stream;
assigning each of the flows to either one of the plurality of packet processors;
using the flow identification information to determine one of the flows to which the input packet belongs to produce a result of determination; and
using the result of determination to supply the input packet to the determined packet processor.

5. A non-transitory computer-readable storage medium on which stored is a packet processing program for use in a packet processing apparatus comprising a plurality of packet processors each processing an input packet included in an input packet stream, said program functioning, when installed in and running on a computer, the computer as:
holding flow identification information about flows included in the input packet stream;
assigning each of the flows to either one of the plurality of packet processors;
using the flow identification information to determine one of the flows to which the input packet belongs to produce a result of determination; and
using the result of determination to supply the input packet to the determined packet processor.

6. A packet processing system comprising:
a plurality of communication terminals communicating with each other by sending or receiving a packet;
a plurality of packet processors each processing an input packet included in an input packet stream;
a flow identification information manager holding flow identification information about flows included in the input packet stream;
a flow assigner assigning each of the flows to either one of said packet processors;
a packet identifier operative in response to the flow identification information for determining one of the flows to which the input packet belongs to produce a result of determination; and
a packet distributor operative in response to the result of determination for supplying the input packet to the determined packet processor.

7. The system in accordance with claim 6, further comprising a flow identification information acquirer analyzing a signal provided from said plurality of communication terminals for obtaining the flow identification information.
